(19) United States
(12) Patent Application Publication
(10) Pub. No.: US 2012/0293532 A1
(43) Pub. Date: Nov. 22, 2012

(54) DRIVER-DEFINED SCREEN BACKGROUND FOR A DISPLAY IN A VEHICLE

(75) Inventor: Markus ARMBRUST, Wonsheim (DE)

(73) Assignee: GM GLOBAL TECHNOLOGY OPERATIONS LLC, Detroit, MI (US)

(21) Appl. No.: 13/472,815

(22) Filed: May 16, 2012

(30) Foreign Application Priority Data
May 17, 2011 (DE) 10 2011 101 702.3

(51) Int. Cl. G09G 5/10

(52) U.S. Cl. 345/589

(57) ABSTRACT

A method for operating a display of a driver information system is provided. On the display, an image is shown, in the foreground of which driver information appears, and in the background of which a user-specific background image appears. The method includes dimming or hiding the user-specific background image in case of necessity.

### CROSS-REFERENCE TO RELATED APPLICATION

This application claims priority to German Patent Application No. 10 2011 101 702.3, filed May 17, 2011, which is incorporated herein by reference in its entirety.

### TECHNICAL FIELD

The technical field generally relates to a method for operating a display of a driver information system on which an image is displayed, the foreground of which shows driver information and the background of which a shows a background image preset for a given user.

### BACKGROUND

DE 10 2006 060 187 A1 discloses a driver information system for the graphical display of driver information and a vehicle. The driver information system provides for the presentation of driver information from various individual devices of the vehicle in the foreground of the graphical display, the background being adaptable to the individual user. An interface is provided in the vehicle for this purpose, via which the user-specific data for designing the background may be loaded into a data memory.

The drawback of this driver information system is that the driver information presented in the foreground may be difficult to make out depending on the design of the background image, with the result that reading the information presented on the display requires considerable concentration, and when reading the driver information the driver is distracted to a significant degree, particularly at high speeds. This results in an increased risk of accident.

At least one object herein is therefore to improve the driver information system in such manner that the legibility of the driver information displayed when the vehicle is in operation is improved. In addition, other objects, desirable features and characteristics will become apparent from the subsequent summary and detailed description, and the appended claims, taken in conjunction with the accompanying drawings and this background.

### SUMMARY

A method for operating a driver information system display on which an image is represented is herein provided. The foreground of the display shows driver information and the background shows a background image designed for an individual user, wherein the background image is dimmed or hidden in case of necessity. As a consequence the driver information on the display in the foreground of the image becomes easily discernible and the driver is no longer distracted by the background image while reading the display. It is thus possible to read the display faster and the risk of accident is reduced significantly.

As used herein, the term “the case of necessity” means exceeding a limit speed. In one embodiment, the limit speed is below 20 km/h, for example equal to 7 km/h.

In another embodiment, the case of necessity is the display of high-priority driver information in the foreground of the image, particularly the display of a hazard warning. In this context, notification of a traffic jam, roadworks, a pedestrian crossing, excessive speed or similar may be considered examples of high-priority driver information.

In one embodiment, the background image is hidden as the vehicle speed increases. For example, the background image is dimmed as a function of the increasing speed of the vehicle above the limit speed. In another embodiment, in the case of high-priority driver information, the background information is hidden immediately.

It is also possible for the driver to hide the background image. The background image is preferably hidable manually, alternatively or additionally thereto. The hiding function may be voice-controlled.

The image background that appears in the display is preferably monocolored after the user-specific background image has been hidden. In this embodiment, it is preferable for the colour that is displayed with the background image is hidden to be preset for a given user, the colour of the driver information displayed in the foreground preferably also being preset for a given user.

The capability of allowing the background image and/or the colours to be preset for a given user also extends to the setting of different background images and/or colours for different drivers of the vehicle.

In an embodiment, the image is also divided into areas in which grouped driver information is displayed, wherein one colour is provided in the background and one colour is provided for the driver information presented in the foreground for each driver information group. Such driver information groups are for example hazard information or driver information relating to the current journey, particularly the vehicle speed, engine speed, fuel tank fill level, outside and inside temperatures, engine temperature and the like, or driver information concerning maintenance of the vehicle, particular fill level displays for the coolant and/or brake fluids, faults in the lights, service intervals and similar. Further driver information groups also include multimedia information from a radio or CD player, navigation information from a navigation device or information about telephone calls from a mobile phone. It is especially preferred if the colours of the background and the colours of the driver information groups displayed in the foreground are provided so as to be at least partially selectable in this embodiment as well.

The user-specific background image can be loaded into a data memory of the driver information system via an interface, particularly a USB interface (universal serial bus). Multiple background images can be loadable; the one background image currently being displayed in the background has been preset for a given user.

A driver information system that utilizes the method described above is also provided herein. The driver information system comprises a user interface for loading the background image, a data memory for storing the background image, an interface for loading driver information, a processor unit for controlling the driver information system and a display for showing the driver information and the background image.

In an embodiment, the user interface is a USB interface. It can be introduced into the passenger compartment of the vehicle and can be particularly easily accessible via a cable with a connector plug. In this embodiment, the background image may be loaded into the data memory of the driver information using a portable storage medium for example. However, in principle any conventional interface is usable, for example even a wireless interface.

The interface for loading driver information enables driver information to be loaded from a wide variety of devices on the vehicle, for example, a standardized bus interface.

In an embodiment, the display is a liquid crystal display (LCD) screen, for example, a thin film transistor (TFT) screen. In this case, the installation space required for the display is small. However, any other type of display with which images can be presented in overlay video is possible, so that the background image is displayed in the background and the driver information is displayed in the foreground.

In another embodiment, the display is a touchscreen, so that settings for the background image and/or the colours may be made by the driver directly on the display. Alternatively or additionally thereto, the driver information system comprises a keypad for manual input.

The display has a low voltage differential signalling (LVDS) interface, a high definition multimedia interface (HDMI) interface, and/or a DisplayPort interface, via which it may be connected to the processing unit, in accordance with an embodiment. In principle, however, other interfaces may also be used.

In order to minimise the installation space and cost, the processor unit can have the form of a microcontroller in which essential peripheral functions are at least partially integrated. An LCD controller and driver are preferably incorporated for integrating the display. A USB and/or inter-integrated circuit (I2C) and/or serial interface can be incorporated for integrating the data memory. A USB and/or Ethernet and/or wireless local area network (WLAN) interface can be incorporated for integrating the user interface. A controller area network (CAN) and/or local interconnect network (LIN) interface can be incorporated for integrating the bus interface for loading the driver information. In principle, however, it is also possible to construct the processor unit with separate periphery modules and if desired a microprocessor instead of the microcontroller.

In a an embodiment, the driver information system further comprises an input interface for hiding the background image by voice and/or manual control, with which the driver is able to hide the background image himself

### BRIEF DESCRIPTION OF THE DRAWINGS

The various embodiments will hereinafter be described in conjunction with the following drawing figures, wherein like numerals denote like elements, and wherein:

FIG. 1 shows in FIG. 1(a) a driver information system display on which an image is shown, in which driver information appears in the foreground and a background image appears in the background, and in FIG. 1(b) the display of FIG. 1(a), wherein the background image shown in the image background of FIG. 1(a) is hidden and only the driver information appears; and

FIG. 2 is a diagrammatic representation of a driver information system according to an exemplary embodiment.

### DETAILED DESCRIPTION

The following detailed description is merely exemplary in nature and is not intended to limit the various embodiments or the application and uses thereof Furthermore, there is no intention to be bound by any theory presented in the preceding background or the following detailed description.

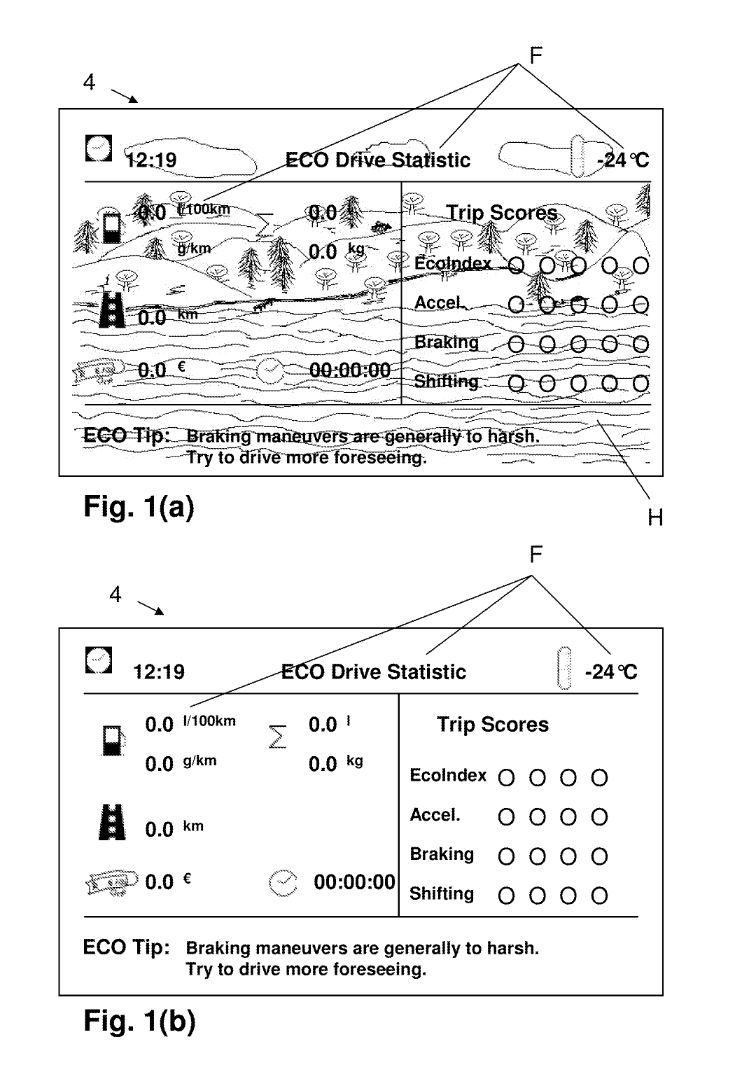

FIG. 1 shows in FIG. 1(a) a display 4 of a driver information system 10 (not shown), on which an image appears. Driver information F is displayed in the foreground and a background image H is displayed in the background. FIG. 1(b) is the display 4 of FIG. 1(a), wherein the background image H displayed in the image background of FIG. 1(a) is hidden and only the driver information F appears.

It may be seen in FIG. 1(a) that the driver information F represented in the foreground is difficult to discern because of the background image H that appears in the background. Consequently, the driver of the vehicle is very significantly distracted while reading display 4.

In contrast, the driver information F displayed after background image H is hidden is immediately discernible and can be read very quickly. The risk of accident due to distraction while reading the display is thus reduced significantly.

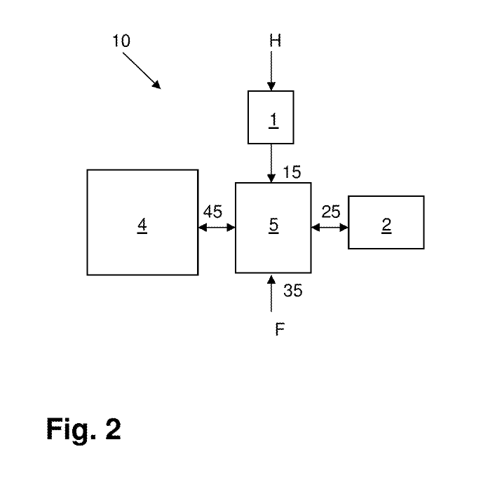

FIG. 2 is a diagrammatic representation of the driver information system 10 according to an embodiment.

Driver information system 10 comprises the display 4 for showing an image, in the foreground of which driver information F may be displayed and in the background of which a background image H may be displayed. Display 4 is connected to a processing unit 5 via an interface 45, preferably an LVDS interface. Processing unit 5 can be configured as a processor-controlled electronic unit, particularly a microcontroller. It is provided in order to process background image H and driver information F, and in order to control driver information system 10.

In order to load background image H, driver information system 10 comprises a user interface 15 that is easily accessible for the driver, for example via a connector plug 1 in the passenger compartment of the vehicle. User interface 15 is preferably configured as a USB interface.

In order to store background image H or multiple background images H, a data memory 2 is provided that is connected to processing unit 5 via a memory interface 25. This enables background images H to be loaded into data memory 2 via processor unit 5 from user interface 15.

Driver information system 10 further comprises a bus interface 3 for loading driver information F. The bus is preferably connected to a plurality of devices in the vehicle so that driver information system 10 may be used to display driver information F from as many of the devices connected to the bus as possible.

In order to enable settings to be made for driver information system 10, in an embodiment display 4 is configured as a touchscreen. Alternatively or in addition thereto, however, a keypad may also be provided to serve as the user interface for the driver. This makes it possible for the driver to make entries on display 4, for example to select the background image H and/or the colours in display 4.

In a preferred embodiment, driver information system 10 is also equipped with an input interface (not shown), at which the driver may hide background image H directly. The input interface is for example configured as a switch for hiding background image H manually. Additionally or alternatively thereto, however, is also conceivable to provide for hiding the image by voice control means.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating a display of a driver information system, on which an image is shown, in the foreground of which driver information appears, and in the background of which a user-specific background image appears, the method comprising the steps of:
dimming or hiding the user-specific background image in case of necessity.

2. The method as recited in claim 1, wherein dimming or hiding comprises dimming or hiding the user-specific background image when a speed of a vehicle housing the driver information system exceeds a limit speed of 20 km/h.

3. The method as recited in claim 1, wherein dimming or hiding comprises dimming or hiding the user-specific background image when high-priority driver information is displayed in the foreground of the display

4. The method as recited in claim 3, wherein dimming or hiding comprises dimming or hiding the user-specific background image when a hazard warning is displayed in the foreground of the display.

5. The method as recited in claim 1, dimming the user-specific background image incrementally in case of necessity

6. The method as recited in claim 1, dimming the user-specific background image incrementally as a speed of a vehicle housing the driver information system increases.

7. The method as recited in claim 1, further comprising displaying a monocolor image background after the user-specific background image has been hidden.

8. The method as recited in claim 7, further comprising presetting for a given user the monocolor image background displayed when the user-specific background image has been hidden.

9. The method as recited in claim 1, further comprising presetting for a given user a colour of the driver information displayed in the foreground.

10. The method as recited in claim 9, further comprising presetting for the given user the colour of the driver information displayed in the foreground when the user-specific background image is been hidden.

11. The method as recited in claim 1, further comprising storing the user-specific background image in a data memory of the driver information system.

12. The method as recited in claim 1, wherein selecting the user-specific background image displayed in the background of the display from multiple background images.

13. A driver information system comprising:
a user interface configured for loading a background image;
a data memory configured for storing the background image;
an interface configured for loading driver information from a vehicle that includes the driver information system;
a data processing unit configured for controlling the driver information system; and
a display configured for displaying the driver information and the background image, wherein the display is further configured to dim or hide the background image in case of necessity.

14. The driver information system of claim 13, wherein the display is configured to dim or hide the background image when a speed of a vehicle housing the driver information system exceeds a limit speed of 20 km/h.

15. The driver information system of claim 13, wherein the display is configured to dim or hide the background image when high-priority driver information is displayed in the foreground of the display

16. The driver information system of claim 15, wherein the display is configured to dim or hide the background image when a hazard warning is displayed in the foreground of the display.

17. The driver information system of claim 13, wherein the display is configured to dim the background image incrementally in case of necessity.

18. The driver information system of claim 13, wherein the display is configured to dim the background image incrementally as a speed of a vehicle housing the driver information system increases.

19. The driver information system of claim 13, wherein the display is configured to show a monocolor image background after the background image has been hidden.
